(19) United States
(12) Patent Application Publication
(10) Pub. No.: US 2011/0196723 A1
(43) Pub. Date: Aug. 11, 2011

(54) Virtual Arbitration System and Method

(76) Inventors: David Baszucki, Portola Valley, CA (US); Daniel Salinas, San Francisco, CA (US); John James Shedletsky, III, San Francisco, CA (US)

(21) Appl. No.: 12/701,243

(22) Filed: Feb. 5, 2010

(51) Int. Cl. G06F 3/048; G06F 15/16; G06Q 30/00; G06Q 99/00

(52) U.S. Cl. 705/14.12; 715/757; 705/12; 709/206

(57) ABSTRACT

A three-dimensional virtual world is provided and includes an avatar representing an accusing party in an infringement case over one or more three-dimensional game objects, an avatar representing an accused party in the infringement case, a virtual space arena containing the objects in dispute, a jury box containing avatars representing a jury assembled to preside over the infringement case, and an avatar representing a judge for instructing the jury and for rendering a judgment in the case based on jury input. The jury observes the objects and object functionalities through demonstration of the objects in the virtual arena and supplies an opinion relative to the likeness of the objects to one another according to instruction given by the judge and wherein the judge renders a verdict based on statistical analysis of the opinions collected from the jury.

### BACKGROUND OF THE INVENTION

1. Field of the Invention

The present invention is in the field of online gaming and pertains particularly to methods and apparatus for arbitrating disputes between members of an online community.

2. Discussion of the State of the Art

In the field of online gaming, there are Websites that offer gaming services to clients. Some of these sites include clubs or groups of members of the online community of the gaming site that build new objects for games and these objects are considered the property of the author as far as the online community is concerned. Technical solutions to deal with copyright issues are very challenging. Any test of “sameness” between two objects can be easily gamed. Sometimes (especially when dealing with 3D objects) it becomes very difficult to determine a piece of “stolen” intellectual property from one that is fairly derivative. The potential for false positives that unfairly stifle creativity is also high with any such system.

Therefore, what is clearly needed is a virtual arbitration system in the form of a virtual court that can be used as a venue for resolving disputes among community members over the property rights relative to objects created for game play or for sale to community members.

### SUMMARY OF THE INVENTION

The problem stated above is that a cohesive system for arbitrating infringement issues is desirable for an online gaming community, but many of the conventional means for arbitrating copyright and other IP contests between three-dimensional object creators, such as the current legal system, also create complexity and expense. The inventors therefore considered functional elements of an online gaming community, looking for elements that exhibit interoperability and demonstrative properties that could potentially be harnessed to provide cohesive and binding arbitration results over authorship of three-dimensional gaming objects but in a manner that would not create complexity or undue expenses.

Every online gaming community is propelled by participation of its members, one by-product of which is an abundance of disputes over who are legitimate authors of three-dimensional game pieces or objects. Most such gaming communities employ communication methods such as forums and tools to enable object builders to create new and unique objects that may be purchased by other gamers to add to their repertoire of useable and functional objects for game play and community oriented forums and interactive venues are typically a part of such apparatus.

The present inventor realized in an inventive moment that if, at the point of a dispute, infringement accusers and their accused peers could be persuaded to settle their disputes in a controlled, fair, and cohesive arbitration environment, significant improvement in creativity of unique objects among community members might result. The inventor therefore constructed a unique system and methods for arbitrating disputes among gamers over intellectual property relative to authorship and subsequent use of three-dimensional game objects that allowed users to have their disputes settled in a timely manner in an online venue. A significant reduction in copyright infringement activity among members results, with no impediment to creativity or pursuit of legitimate rights of authors created.

Accordingly, in one aspect of the present invention in an online game community, a method for resolving property rights disputes between users involving authorship of three-dimensional objects is provided comprising the steps (a) receiving a statement of infringement from an accuser through an online venue, (b) collecting a statement from the accused of step (a) and registering a case based on the statements, (c) assembling a jury of peers from the online community, (d) presenting the objects in a three-dimensional virtual space to the jury assembled in (c), (e) extracting opinions of the jury relative to likeness of the objects to one another, (f) running a statistical analysis on results of step (e) to determine a cohesive verdict, and (g) publishing the verdict and implementing one or more actions based on the verdict.

In one aspect of the method, in step (a) the venue is one of email, online post, Web form, or chat interaction, or virtual world. In a preferred aspect of the method, in step (a) the statement of infringement includes identification of the objects in dispute and identification of accusing and accused parties. In one aspect, in step (b) the statement is collected via email, online post, Web form, or chat interaction. In one aspect, in step (b) a registered case includes a case number, party identification information, and statements from both parties.

In one aspect of the method, in step (c) the jury comprises players whom have played the game containing the objects in dispute. In one aspect, in step (c) potential jurors are invited through a message appearing on their personalized gaming login page. In another aspect, in step (c) potential jurors are invited through email or instant message. In one aspect of the method, in step (c) accepting jurors receive a form of compensation for participating. In a preferred aspect, in step (d) the virtual space enables three-dimensional viewing and full operation of any functional features of the objects.

In one aspect of the method, in step (e) the opinions are extracted through a chat interface, email, Web form, a posting board, or a voting engine comprising an interactive voice response (IVR) destination number for jurors to call. In one aspect in step (f) a percentage threshold of the total votes of the jury is required before rendering a verdict. In one aspect, in step (g) the actions include removing any infringing objects from game play, and rewarding winning parties with game currency or an equivalent thereof.

According to one embodiment of the present invention, a three-dimensional virtual world is provided and includes an avatar representing an accusing party in an infringement case over one or more three-dimensional game objects, an avatar representing an accused party in the infringement case, a virtual space arena containing the objects in dispute, a jury box containing avatars representing a jury assembled to preside over the infringement case, and an avatar representing a judge for instructing the jury and for rendering a judgment in the case based on jury input. The jury observes the objects and object functionalities through demonstration of the objects in the virtual arena and supplies an opinion relative to the likeness of the objects to one another according to instruction given by the judge and wherein the judge renders a verdict based on statistical analysis of the opinions collected from the jury.

In one embodiment the number of actual jurors is larger than the representative avatars such that a single avatar represents multiple jurors having a same opinion. In this embodiment when statistical analysis of actual jurors determines a number of same opinions equal to the number of jurors represented by a single avatar, that avatar is assigned an opinion to render. In one embodiment the opinions reached by actual jurors are transparent to the accuser and the accused.

In one embodiment of the present invention, the virtual world further includes an avatar representing an enforcer for removing and or destroying a three-dimensional object deemed an infringing object by the assembled avatar jury. In one embodiment the virtual world further includes an avatar representing a court recorder for recording the case proceedings held within the virtual world. In one embodiment the virtual world further includes an avatar representing a prosecuting attorney for the accuser and an avatar representing a defending attorney for the accused.

### BRIEF DESCRIPTION OF THE DRAWING FIGURES

FIG. 1 is an architectural overview of an online gaming network supporting a virtual arbitration system according to an embodiment of the present invention.

FIG. 2 is an exemplary screen shot of a gaming site login page according to an embodiment of the present invention.

FIG. 3 is an exemplary screen shot of a personalized game page of a gaming site according to an embodiment of the present invention.

FIG. 4 is an exemplary screen shot of a Web-based complaint form according to an embodiment of the present invention.

FIG. 5 is an exemplary screen shot of a Web-based notice to appear according to an embodiment of the present invention.

FIG. 6 is a flow chart illustrating steps for registering and scheduling a virtual court case according to an embodiment of the present invention.

FIG. 7 is a flow chart illustrating steps for processing a virtual court case according to an embodiment of the present invention.

FIG. 8 is an exemplary screen shot of a three-dimensional virtual court game according to an embodiment of the present invention.

### DETAILED DESCRIPTION

The inventor provides a system and methods for virtual arbitration of object ownership and use disputes arising between members of a closed online gaming community. The methods and apparatus of the present invention are described in enabling detail using the following examples, of which some may represent more than one embodiment of the present invention.

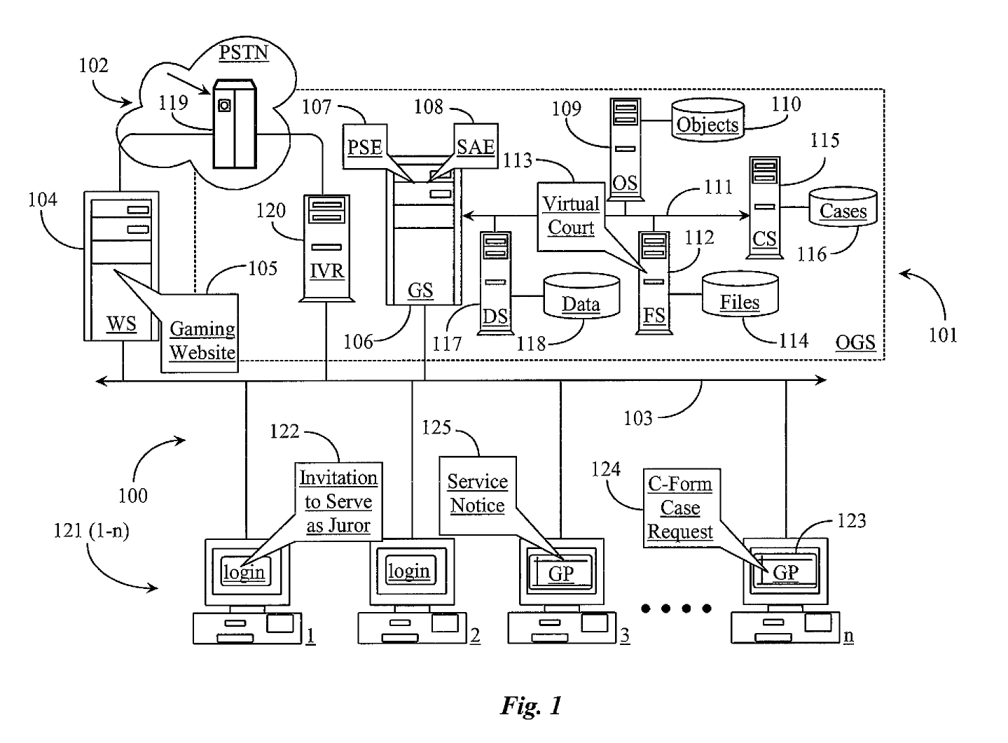

FIG. 1 is an architectural overview of an online gaming network 100 supporting a virtual arbitration system according to an embodiment of the present invention. Gaming network 100 includes the well-known Internet network represented logically herein by an Internet backbone 103. Internet backbone 103 represents all of the lines, equipment, and access points that make up the Internet network as a whole including any connected sub-networks. Therefore there are no geographic limitations to the practice of the present invention. Internet backbone 103 will hereinafter be referred to as simply Internet 103.

Internet 103 is a carrier network for an online gaming service (OGS) 101. OGS 101 may represent any gaming service provider that is adapted to provide online gaming and community member interaction through an online gaming Website or portal. A Web server (WS) 104 is illustrated in this example and includes a digital storage medium coupled thereto that is adapted to contain all of the software (SW) and data required for enabling server function as an Internet-based Web server. WS 104 may be hosted on the physical premises of OGS 101 or it may be a piece of third-party equipment. WS 104 has an online gaming Website hosted thereon and provided by OGS 101. WS 104 contains a gaming Website 105 that is available to clients and potential clients of OGS 101 through a subscription to the gaming service.

Gaming Website 105 includes multiple Web pages such as a community member registration page, a dynamic personalized gaming page for each registered community member, an various other pages dedicated to different aspects of an online gaming community portal. Gaming Website 105 is provided by OGS for clients of the service such as clients 121 (1-n). Clients 121 (1-n) are represented in this example by personal computer (PC) icons. However, other Internet capable appliances may also be used to access Website 105 on server 104 to play games and interact with other community members. Clients may access WS 104 using a variety of browser-based appliances like a personal digital assistant (PDA), a Laptop or notebook computer, a smart phone (3/4G), a game box, or some other Internet capable appliance that includes a graphics display, input capability, and a browser application for navigating the network. Clients 121(1-n) are connected to Internet backbone 103 by way of Internet access lines. Any one of several available Internet access methods may be used to connect to Internet 103 such as digital subscriber line (DSL), integrated services digital network (ISDN), broadband, or a T(X) local area network (LAN) based Internet connection. In this example clients 121(1-3) are in a state of login to Website 105 hosted by WS 104. Client 121(n) has logged in to gaming site 105 and has accessed a personal gaming page of Web site 105. It is noted herein that clients who log in to play virtual games are connected to a gaming server (GS) 106 within the physical premise of OGS 101.

GS 106 is connected to Internet backbone 103 and includes a digital storage medium coupled thereto that contains all of the software (SW) and data required to enable server function as a game server. GS 106 includes a physics simulation engine (PSE) 107 adapted to physically simulate motion and other forces relative to game play activities initiated by clients 121(1-n) whom are also considered to be community members of Web site 105. GS 106 includes a statistics analysis engine (SAE) 108. More about SAE 108 and the relevance thereof to the present invention is described later in this specification. GS 106 has access to several other servers over a digital network 111. Network 111 supports an object server (OS) 109. OS 109 includes a digital storage medium coupled thereto which contains all of the SW and data required to enable server function as a game object server and image server. OS 109 may be thought of as a media server in the abstract and is adapted to serve three-dimensional game objects and images to game server 106 during game rendering.

Network 111 supports a file server (FS) 112. FS 112 includes a digital storage medium coupled thereto which is adapted to contain all of the SW and data required for server function as a file server. FS 112 is responsible for serving game files comprising virtual games which depend on OS 109 for retrieval of game media such as the images and objects for particular games. OS 109 is coupled to a database 110 adapted to contain all of the objects and images for all of the games rendered by GS 106. FS 112 is coupled to a database 114 which is adapted to contain all of the game files comprising individual games that GS is able to render for clients engaged in game play.

Network 111 supports a data server (DS) 117. Data server 117 includes a digital storage medium coupled thereto and adapted to contain all of the SW and data required to enable server function as a data server. DS 117 is coupled to a database 118 adapted to contain data about clients such as registration data, contact information, billing information, and any other data deemed pertinent to management of community member subscription status and game player status.

Network 111 supports a case server (CS) 115. CS 115 includes a digital storage medium coupled thereto and adapted to contain all of the SW and data required to enable server function as a game server. CS 115 is coupled to a database 116 adapted to contain cases involving ongoing disputes over virtual object ownership and use between community members like clients 121 (1-n). A case documents the dispute and identifies the contesting parties in the dispute. A dispute coved under this definition includes a dispute initiated by a complaint from a community member involving intellectual property right violations alleged by that member relative to one or more three-dimensional objects purportedly created by or otherwise owned by the member.

In one embodiment of the present invention, FS 112 includes a three-dimensional virtual world or game termed a virtual court 113 in this example. Virtual court 113 is a game that simulates a real-life courtroom adapted to facilitate resolution of intellectual property rights disputes over objects created or otherwise presumed owned by community members. Virtual court 113 is not absolutely required in order to practice the broader invention of a system for settling disputes ongoing between certain community members over intellectual property rights relative to created or otherwise owned three-dimensional objects or other content authored by a community member such as one of clients 121 (1-n).

Client 121(n) has a personalized game page 123 displayed on the computer monitor of the Internet capable appliance operated to access Web site 105, in this case, a PC. Client 121(n) may be presented with a complaint and case request form 124. Complaint form 124 facilitates the formal process of taking another community member to task over intellectual property rights relative to object ownership. Client 121(n) may execute, populate, and submit complaint form 124 in a process of accusing one or more community members of infringement involving intellectual property. Once populated, complaint form 124 may be submitted to OGS 101 through Web site 105.

Complaint forms submitted to the system by community members for prosecuting are further processed to obtain more information about the dispute and the alleged violating member and to verify existing information known about the dispute such as the identification of the compromised and the offending object or objects. Part of the unique process is soliciting a pool of community members to serve as jurors for a case involving property rights over objects contained in database 110. Each object created by a community member and stored in object database 110 is time-stamped at the time of creation so jurors immediately know which of two contested objects was first created and stored. However, time stamp information for an object alone is not sufficient to determine whether another object having a later stamp is an infringing object. Jurors solicited to review cases are given access to the objects and the functionality of the objects. Object appearance or “look” and object functionality (what the object can do) are considered by jurors before they decide if an object is in violation or not with respect to being copied or simply created from inspiration from another object.

After a registered case has been generated and jurors have been assembled to review the facts in the case, the system collects all of the opinions of the jurists and performs an analysis on the aggregated opinions to determine if a cohesive verdict can be arrived at to resolve the dispute in favor of one member or another. In one embodiment the process plays out over a predictable period of time it takes to assemble the jury, present the objects and case facts for review, collect the responses from the jury, analyze the responses and render a verdict along with a sentence if warranted. In one embodiment the entire process is facilitated by a virtual world representing the court process.

Jurors may be randomly selected and invited to serve on a case. In this example, client 121(1) has an invitation message 122 displayed at login. A juror may signup to serve by clicking on the message to call up a Web form or some other interface to complete juror registration. Jury opinions can be collected using various communication mechanisms. In one embodiment juror opinions are gathered through email, IM, or Web post.

In one embodiment OGS 101 includes an interactive voice response (IVR) facility accessible through a PSTN network 102 and a local telephony switch 119. IVR 120 includes a digital medium coupled thereto that contains all of the SW and data required to enable function as an interactive voice response unit. In the embodiment using an IVR, jurors may call in to a provided 1-800 number when they have reached opinions, specifically if the offending object indeed infringes another object or not. Gaming Web-site 105 may include a call now, or juror report call-in link embedded in one or more pages of the site. Server 104 has a bridged connection to the PSTN 102 and to switch 119 where IVR functionality takes over. The directional arrow in cloud 102 represents calls incoming from any where in the PSTN so jurors may call in to report. It is noted herein that the number of jurors polled is sufficient larger than a traditional jury of, for example, 9 individuals.

The number of jurors working one case may exceed 50 members and may approach 100 or more jurists. The larger number provides more reliability in reaching a verdict. Statistical analysis by SAE 108 is performed on opinions collected from jurors to determine if there is a cohesive verdict. A specific threshold may be established for the jury opinion analysis to make sure to facilitate fairness in verdict. After a verdict is handed down, the system or an entity representing the system may render the verdict reached by the jury and then meet out specific punishments for the offending member and, perhaps, rewards for case winners.

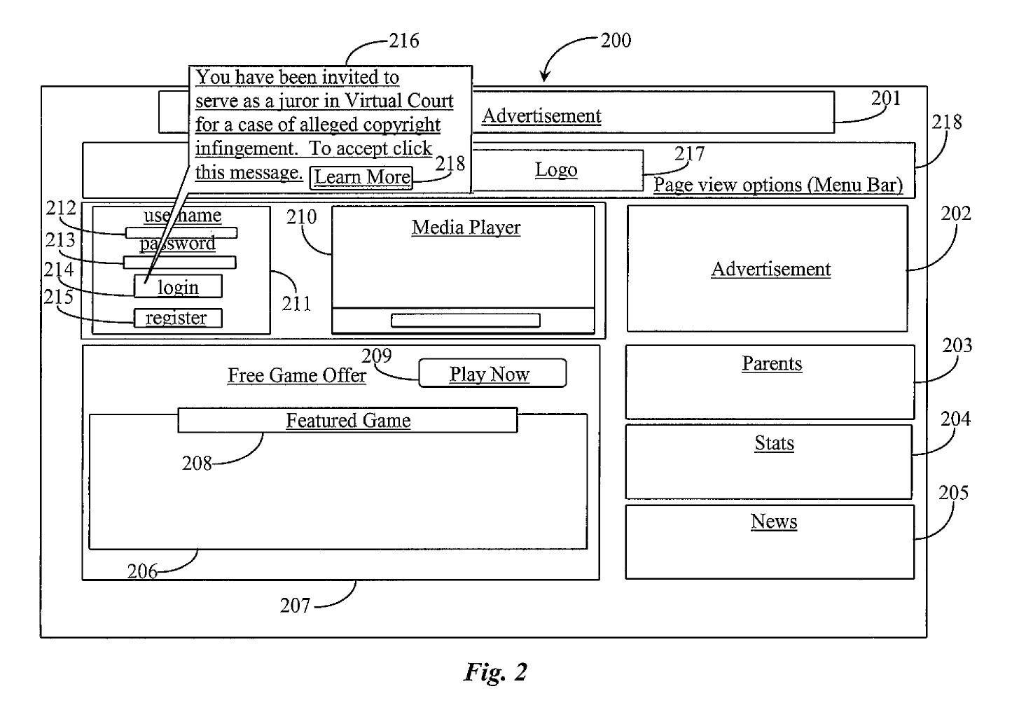

FIG. 2 is an exemplary screen shot of a gaming site login page 200 according to an embodiment of the present invention. Login page 200 represents a log in interface to the gaming Web site (105) illustrated in FIG. 1 above. Log-in interface displays in a browser application as a typical log-in page having a log-in facility 211 among other available page and feature links. Interface 200 includes one or more advertisements (201 and 202). A title bar 218 adapted to display menu options, includes a company logo 117 and may include several other interactive options without departing from the spirit and scope of the present invention.

Interface 200 includes an information block 203 for interacting with parents. A statistics information block 204 is provided for viewing current statistics about game play and member state. A news block 205 is provided to enable readers to access company news. Interface 200 includes a free game offer 207 with a play now button 209. A featured game 206 is displayed along with a link 208 to play the featured game.

A media player 210 is provided featuring video content about games, the community, member accomplishments, or other community issues posted by members or the system. A login interface block 211 is provided with a data input field 212 for entering username, a data input field 213 for entering a password, a login button 214, and a register button 215 for new users who do not yet have a username or password.

In this example a jury invitation 216, analogous to invitation 122 described in FIG. 1, is displayed at the point of login to a personalized game page of the client. Message 216 informs the juror that he or she has been invited to serve as a juror in Virtual Court for a case of alleged copyright infringement. In this case the message simply is attached to the login screens to a number potential jurors and pops up when the login. The selection may be a random selection of a number of community members, say between 50 and 100 members to review a single dispute. Message 216 includes an interactive link 218 (Learn More) that allows the potential juror to learn about the virtual court system and what if any rewards or expectations are attached to the invitation.

In one embodiment there are incentives offered to community members who agree to participate on a jury in virtual court. In one embodiment there may be certain restrictions applied to potential jurors. For example, if the potential juror knows one of the parties to the dispute, he or she may be prevented from serving for that particular dispute. In one embodiment a jury selection process may be conducted wherein potential jurors are interviewed by Web form, chat, or some other interactive method. They may be interviewed by a “virtual” prosecutor and by a “virtual” defense counsel before being accepted on the jury. In a typical scenario however, a potential juror may become a sitting juror by simply clicking the message to accept the invitation. Potential jurors may also be recruited through email, instant message, chat interface, or other methods of communication.

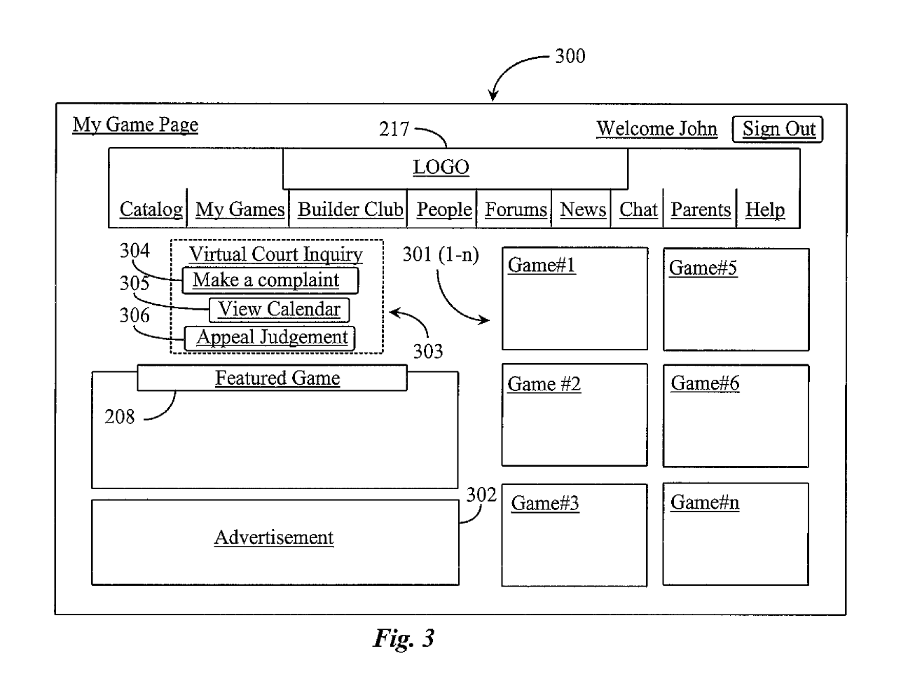

FIG. 3 is an exemplary screen shot of a personalized game page 300 of a gaming site according to an embodiment of the present invention. Gaming page 300 represents a personalized gaming page analogous to game page 123 on client 121(n) of FIG. 1. Game page 300 has a personal greeting (Welcome John) and a sign out button. Game page 300 includes the company logo 217. Personalized gaming page 300 includes a sort order of virtual games and, or worlds 301(1-n) that have been played by, bookmarked by, or visited by the client. Menu options on the personalized gaming page include the self explanatory headings Catalog, My Games, Builder Club, People, Forums, News, Chat, Parents, and Help. An advertisement 302 is illustrated on interface 300 as well as the featured game 208 described previously in FIG. 2.

A virtual court inquiry interface 303 is provided in the personalized game page of any community member for the purpose of enabling that member to make a complaint against one or more other members among other options. An interactive button 304 (make a complaint) is provided in block 303 in this example and if selected, brings up a complaint Web form for data population. In one embodiment there is a court calendar that lists all of the ongoing cases in virtual court. An interactive button 305 (view calendar) is provided to enable a community member to view cases listed in the court docket. In one embodiment an interactive button 306 (appeal judgment) is provided for a community member who has had a judgment made against him or her to launch an appeal process. An appeal process may recount the votes leading to the verdict, and may consider any argument the member has relative to why he or she feels the judgment was wrong. In one embodiment there is no appeal process or calendar view of cases.

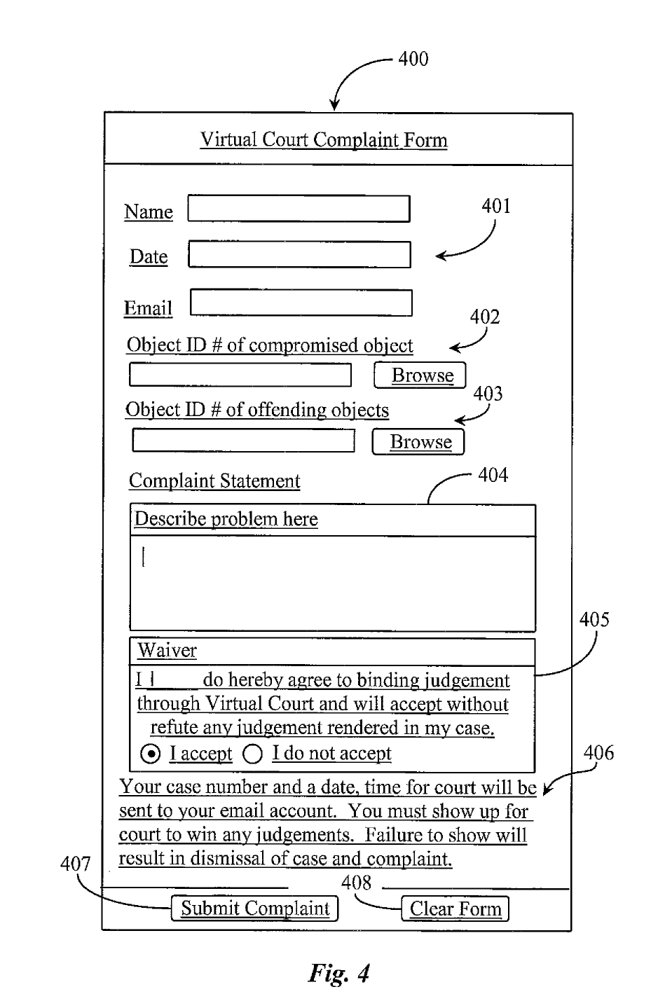

FIG. 4 is an exemplary screen shot of a Web-based complaint form 400 according to an embodiment of the present invention. Complaint form 400 may be launched by a community member that feels one or more other community members have violated his or here property rights relative to one or more gaming objects authored or otherwise owned by the community member. Form 400 includes an information block 401 including a data input field for registering the name of the complaintent, a data input field for entering the date of the complaint, and a data input field confirming the email address of the complaintent.

Form 400 includes a data block 402 containing a data input field for entering the object identification number of the member object that the member believes is compromised by one or more other objects. A browse button may be provided to enable the complaintent to browse for the object in a database list of objects or in a catalog. The identification number of the object may be required by the system in order to proceed with a case. Form 400 includes a data block 403 containing a data input field for entering the object identification number of the offending object or objects that the complaintent believes infringes on the member object or objects. A browse button is provided for the member to find the object or objects in a database list or in a catalog.

Form 400 includes a dialog entry box 404 for entering a complaint statement that describes the problem the member is having. The problem may be described using a maximum number of words allowed for the complaint statement. In one embodiment form 400 includes a waiver block 405 containing a statement acknowledging that the member must accept any judgment handed down as a condition for participating. A radio button for accepting the waiver and one for rejecting the waiver are provided. Not accepting the waiver may result in the complaint being voided by the system. At the bottom of form 400 a generic message 406 informs the complaintent that the case number and the date and time for court will be sent in email or some other venue the member has. In this case it is assumed that virtual court is held at specific dates and times for scheduled court cases.

If virtual court is implemented as a virtual world, the member may be required to login to the virtual world on the stated data and time in order to win any judgment. In this case, failure to show may result in a case dismissal. At the very bottom of form 400, there is a button 406 for submitting the finished complaint and a button 407 for clearing the form. Other mechanisms may be used to facilitate submission of a complaint by a community member other than Web form. Email IM, chat, and other communication regimens may be used to convey the complaint information to the system for the purpose of creating a case.

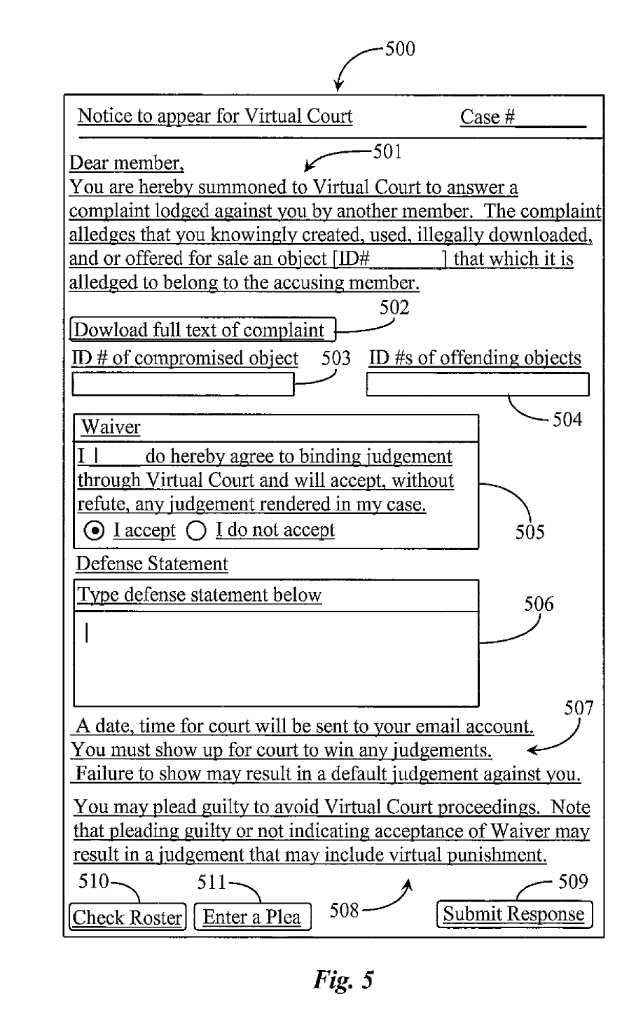

FIG. 5 is an exemplary screen shot of a Web-based notice to appear 500 according to an embodiment of the present invention. Web form 500 may be generated as a result of a valid complaint and case generation. Form 500 may be caused to appear in display on a member's Internet capable appliance when the member log into his or her personal gaming page. Form 500 includes a case registration number or case number. A message 501 is provided in form 500 that informs the recipient that they are summoned to virtual court to answer a complaint lodged against them by another member, namely the complaintent. The message alleges the offending activity and identifies the object ID number or numbers of the complaintent's object or objects believed to be compromised.

Form 500 includes a link 502 for download of the full complaint lodged against the recipient. A data field 503 is provided that contains the ID number or numbers of the compromised object(s). A data field 504 contains the ID number or numbers of the offending object(s). This information enables the accused party to see the objects in question before responding to the action.

Form 500 includes a waiver 505 for the accused party to accept. In this case the waiver simply compels the accused to accept without refute any judgment rendered in the case as a condition of having the case heard in virtual court. Virtual court may be a transparent series of processes, or it may be contained in a virtual world in one embodiment. In this case appearing means the accused must appear in virtual court in the form of logging in to the virtual world representing the court at the date and time of the case.

Form 500 includes a dialog entry box 506 for the accused to type in and submit a defense statement. A defense statement may, for example, explain the case of the accused as to why the accused believes that the offending object does not infringe on the complaintent's object. Form 500 includes a message 507 that informs the accused that a date and time for court will be sent to the accused party in an email or in some other communication available to the member. Message 507 informs the accused party that they must show up to court to win any judgments and that failure to show may result in a default judgment against the accused party.

In one embodiment an accused party may be allowed to enter a preliminary plea of guilty in order to avoid any virtual court proceedings or necessity to appear. A message 508 reminds the accused party that pleading guilty or not accepting the waiver may result in a default judgment against the member that may include a prescribed punishment for the activity. A button 510 is provided in form 500 to enable the accused party to check the court calendar for cases that are scheduled. A button 511 may be provided to enable the accused to enter a preliminary plea to the accusations. The accused party may submit a populated form 500 by clicking a button 509 for submitting the response. Once the accused party has been served and he or she has replied to the accusation such that the case moves forward, a jury may be solicited to hear the case.

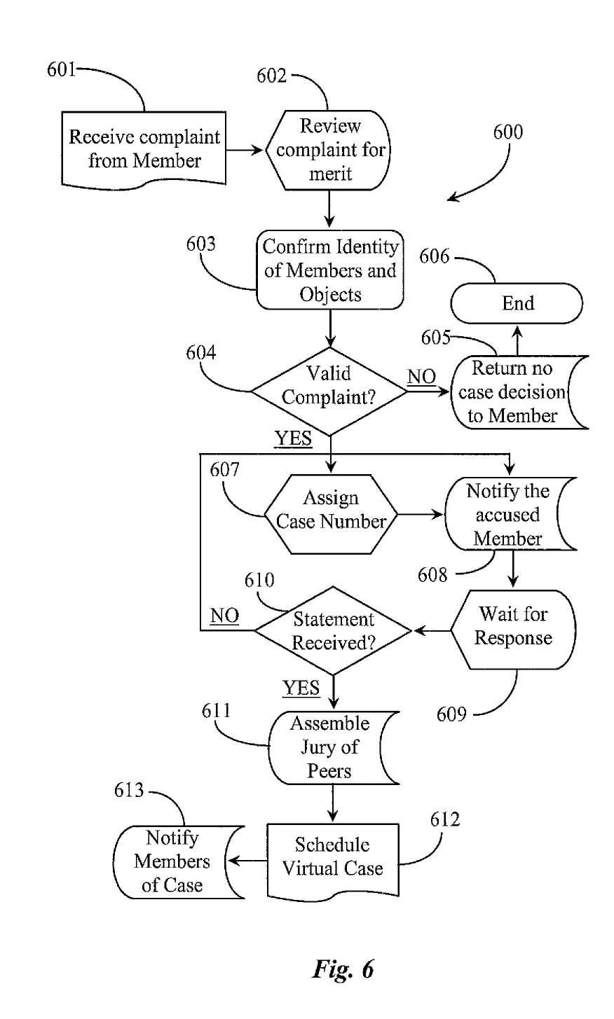

FIG. 6 is a flow chart 600 illustrating steps for registering and scheduling a virtual court case according to an embodiment of the present invention. At step 601 the virtual court system receives a complaint from a community member. In one aspect of the method, the system may review the complaint for merit. For example, if the system finds that the time stamp information of the offending object predates the complaintent's object, then the case would not be accepted. Likewise the complaint must accuse the offending member of an act covered by court proceedings such as copyright violation.

At step 603, the system may confirm the identity of members and objects of the complaint. At step 604 the system determines if the complaint is valid based on previous review and identity confirmation steps. If the system determines that the complaint is not a valid one at step 604, then the system may return a no case decision to the complaining member at step 605. In this case the process for that complaint ends at step 606.

If the system determines in step 604 that the complaint is valid and should proceed, the system assigns a case number for the matter at step 607. At step 608 the system notifies the accused member such as by sending form 500 or by causing it to appear before the accused member when they log into the personal gaming page of the game site. There are many possibilities that might occur where a case may not be able to proceed. For example, it may be that the accused member is no longer an active member of the community. If so, then the case could not proceed.

At step 609 the system waits an allotted amount of time for a response from the accused member in the matter. At step 610 the system determines if the accused member has responded to the complaint. A specific period of time may be set as a window within which the accused member must respond or be considered non-responsive. This period may hinge on log-in history of the accused member where the allotted time is set to be greater that the average interval between logins. In this way it is less likely that the member will miss court because of not logging into the site frequently enough.

If at step 610 the system determines that a response statement from the accused party was not received within the allotted time window, the system may again attempt to notify the member about the case and wait a second amount of time for a response. A response may be a plea of guilty in one embodiment, which may render the case presentation to a jury unnecessary. If at step 610 the system determines that the statement from the accused member was received, the system may begin assembling a jury at step 611. In one embodiment the jury comprises community members not involved with the accused or accusing parties that are invited through random invitation process described earlier in this specification. A jury may comprise 50, 100 or more members so that a cohesive verdict might be reached. In a case where virtual court is a virtual world, a representation of the jury may be included as a number of avatars each representing a number of actual votes made by the actual jury. Therefore, 10 jury avatars may represent 100 actual jurors with one avatar representing 10 votes.

Jurors may respond to the invitation sent to them by the system by simply clicking on the invite. The actual jury may be logged into the virtual court in the embodiment where the virtual court is contained in a virtual world, and may see and witness the functionality the contested objects in real time. It is noted herein that the present invention may apply to any game or virtual world that provides for user-created assets. Assets may include anything in the game or world, such as characters, clothing, weapons, tools, scenery, buildings, vehicles, plants, and etcetera. The possibilities are virtually unlimited. Finer points of jury arbitration may include but are not limited to editing the assets to include building meshes, creating 2D artwork, creating script code, creating 3D solid models, creating 3D parametric models, creating sounds, and so on. After the jury has been established, the system may schedule the case in virtual court at step 612. Case scheduling relies on the ability of the system to generate enough jurors to hear the case and provide responses as to guilty or not guilty for whatever the accusation is. After cases are scheduled, the system may notify all parties at step 613 to the case that the case has been scheduled and will be held in virtual court. Member notification may be performed through email, IM, chat, or other contact methods.

Members that are notified of an upcoming case are obligated to login to the virtual world at the prescribed date and time. In a case where the virtual court is a series of Web processes as opposed to a virtual world, there might be no need to remind members of the case. The outcome of the case may simply be sent to both parties when convenient to the system. A case outcome may include rewards for the case winner and punishments for the case loser. In incentive to complaintents might be extra gaming currency. A punishment for guilty parties might include destruction of the offending object(s) and one or more sanctions relative to game play. A member that abuses the situation by making a false accusation may also be punished. One aspect of punishment might be to temporarily ban the member from the gaming community.

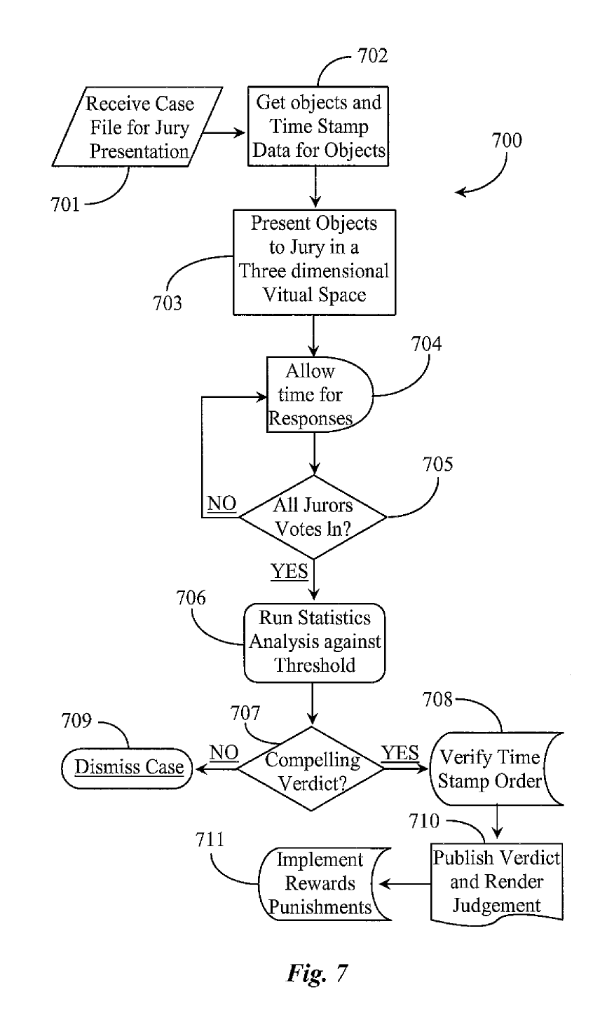

FIG. 7 is a flow chart 700 illustrating steps for processing a virtual court case according to an embodiment of the present invention. The process follows from the process described above. At step 701 the system receives a case for presentation to the jury. At step 702 the system gets the disputed objects and time stamp data about the objects. At step 703 the system presents the objects to each actual juror in a three-dimensional space such that the objects may be rotated, and tested in terms of functionality.

At step 704 the system allows time to aggregate all of the responses from the jury. This amount of time may be equal to the average login time interval for the invited group as deduced from login history of the group. At step 705 the system determines if all of the juror votes are in. If the system determines at step 705 that not all the votes are in, the process may loop back to step 704 and may allot some more time before settling on the number of responses received. It is noted herein that in one embodiment serving as a jurist in virtual court is voluntary and not subject to punishment for not serving. In this case incentives might be offered for service. In one embodiment serving is a patriotic requirement and some form of punishment may be meted out to those potential invitees who do not respond. There are many variant scenarios that are possible.

At step 705, if it is determined that all of the jurors votes have been received, the system may run statistical analysis on the results in order to develop a cohesive verdict at step 706. This step may include a threshold value of same votes that must be met or exceeded in order to reach a verdict. For example two thirds of the total votes may be required to be guilty votes before the system may render a guilty verdict. In order to obtain a vote from a juror, the juror is given the opportunity to review the objects in question and to test the functionality of the objects before being required to decide. In one embodiment each juror is provided with a testing space that contains the objects wherein the jurist may spend a certain amount of time working with both objects before deciding if they are substantially the same or markedly different from one another. The time stamp information of the objects may be withheld from the jury to avoid any prejudgment. Similarly, the contestants may be forbidden to include any time stamp information with their statements in case those statements are made available to the jurists.

At step 707 the system decides if the results of statistical analysis show a compelling verdict. If at step 707 a compelling verdict is not clear meaning that the results could not produce a cohesive verdict in light of the conditions of the case, the case may be dismissed by the system in step 709. For example if the threshold value of guilty or innocent is not breached by the total number of same votes, the case might be dismissed. In case of dismissal, the case might be retried one time using a different jury pool assembled for the purpose. In another embodiment case dismissal is reported immediately to the parties of the matter.

If at step 707 the system decides that it has reached a compelling verdict, at step 708 the system may verify the time stamp order of the objects. At step 710 the system may publish the verdict and render a judgment in the case that includes a description of the rewards and punishments that will be implemented. At step 711 the system then implements the rewards and punishments in the case. One punishment for the guilty party is the destruction and removal of the offending object or objects from the object database. The guilty party may be required to forfeit game bucks or credits, or may be banned temporarily from building any new objects.

The guilty party may also be banned from interacting with the community for a period of time. Rewards for the winning party may be an increase in game credits or game bucks. In one embodiment the reward is publishing of the win in a court journal. Rewards for jurors may include free one time game tickets or a gift certificate for buying objects from an object catalog. In one aspect of the invention, process 700 actually occurs within a virtual world representing virtual court.

In one embodiment, an Escrow fund is established so that the creator of a virtual asset does not receive payment for assets sold until some time period has expired. This escrow fund allows for transfer of funds accrued by a copier to the original creator of a contested asset in the event of judgment for the complaintent or accuser. The escrow account could be set up for proceeds of a created asset to accrue for a reasonable period, say 90 days before the alleged creator can have access to the funds.

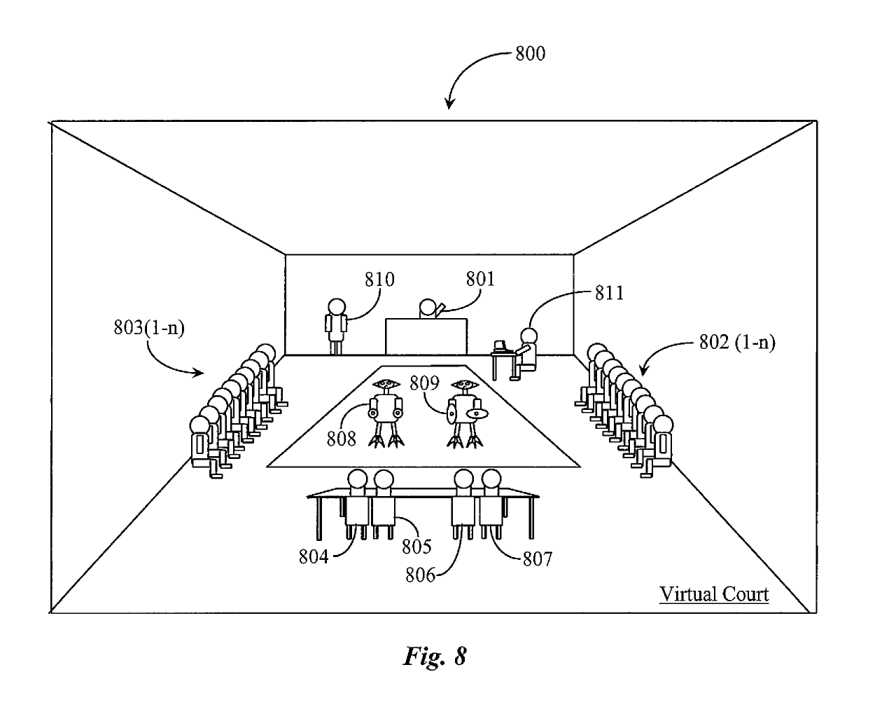

FIG. 8 is an exemplary screen shot of a three-dimensional virtual court game 800 according to an embodiment of the present invention. In one embodiment of the present invention virtual court is played out within a virtual world representing a court room and court participants. Virtual court 800 includes avatars that may represent parties to a case, jurors hearing the case, and other potential court personnel. In this exemplary rendition of a three-dimensional virtual court room, an avatar 804 and an avatar 805 may represent an accused party and a defense attorney for the accused party. A defense attorney may be a community member that knows the accused party and that was chosen by the accused party to aid in representing the accused party in the matter.

An avatar 806 and an avatar 807 may represent the aggrieved party and a prosecuting attorney that is a community member that knows the complaintent and is chosen to represent the complaintent. In one embodiment a group of avatars 802(1-n) represents the jury assembled to here the case in virtual court. There are 10 avatars in this example that may represent 100 jurors, for example. One avatar 802(1-n) represents 10 actual jurors in this example. When statistical results are in for the actual jurors, each juror in virtual court 800 would have a verdict based on 10 votes that are the same. So if one juror says guilty, it means that there were 10 guilty votes assigned to that juror. If out of 100 votes there are 60 guilty votes then 6 avatars will vote guilty and 4 would vote innocent.

A group of avatars 803(1-n) may represent a group of spectators made up of community members who are interested in the outcome of the case. Virtual court 800 may include a virtual judge 801 and a court bailiff 810. An avatar 811 may represent a court recorder. In the center of the courtroom an arena contains the actual three-dimensional objects that are subject to the dispute. Object 808 may be the complaintent creation while object 809 may be the defendant's creation. In this particular example, both objects are virtually identical except for the weapons mounted where their hands would otherwise be. The actual jury may be logged into virtual court 800 and may be able to witness the several views of objects 808 and 809 as well as the functionality of the objects like how they move, how they fire their weapons, and so on. The jury viewing this activity may submit their votes online transparent to the other participants. The attorneys may make opening and closing statements. There may be witnesses and so on in a simulation of a real court proceeding.

In one embodiment virtual court 800 may handle disputes other than disputes about authorship of gaming objects. Virtual court 800 could be a venue for arbitrating any type of dispute between community members if both agree to have it settled there. After virtual court, there might be a celebration room or world where the winner, family, and friends may gather to celebrate. There may be virtual jail where bailiff 810 takes the guilty party for a period of suspension. Other aspects of virtual court might include a destroyer avatar that handles symbolic destruction of and removal of the offending object from the court and from the object database. Virtual court 800 may include expert witnesses, reporters, witnesses, and so on.

It will be apparent to one with skill in the art that the virtual arbitration system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. In an online game community, a method for resolving property rights disputes between users involving authorship of three-dimensional objects comprising the steps:
(a) receiving a statement of infringement from an accuser through an online venue;
(b) collecting a statement from the accused of step (a) and registering a case based on the statements;
(c) assembling a jury of peers from the online community;
(d) presenting the objects in a three-dimensional virtual space to the jury assembled in (c);
(e) extracting opinions of the jury relative to likeness of the objects to one another;
(f) running a statistical analysis on results of step (e) to determine a cohesive verdict; and
(g) publishing the verdict and implementing one or more actions based on the verdict.

2. The method of claim 1 wherein in step (a), the venue is one of email, Web form, online post, chat interaction, or virtual world.

3. The method of claim 1 wherein in step (a) the statement of infringement includes identification of the objects in dispute and identification of accusing and accused parties.

4. The method of claim 1 wherein in step (b) the statement is collected via email, Web form, online post, or chat interaction.

5. The method of claim 1 wherein in step (b) a registered case includes a case number, party identification information, and published statements from both parties.

6. The method of claim 1 wherein in step (c) the jury comprises players whom have played the game containing the objects in dispute.

7. The method of claim 1 wherein in step (c) potential jurors are invited through a message appearing on their personalized gaming login page.

8. The method of claim 1 wherein in step (c) potential jurors are invited through email or instant message.

9. The method of claim 1 wherein in step (c) accepting jurors receive a form of compensation for participating.

10. The method of claim 1 wherein in step (d) the virtual space enables three-dimensional viewing and full operation of any functional features of the objects.

11. The method of claim 1 wherein in step (e) the opinions are extracted through a chat interface, email, Web form, a posting board, or a voting engine comprising an interactive voice response (IVR) destination number for jurors to call.

12. The method of claim 1 wherein in step (f) a percentage threshold of the total votes of the jury is required before rendering a verdict.

13. The method of claim 1 wherein in step (g) the actions include removing any infringing objects from game play, and rewarding winning parties with game currency or an equivalent thereof.

14. A three-dimensional virtual world comprising:
an avatar representing an accusing party in an infringement case over one or more three-dimensional game objects;
an avatar representing an accused party in the infringement case;
a virtual space arena containing the objects in dispute;
a jury box containing avatars representing a jury assembled to preside over the infringement case; and
an avatar representing a judge for instructing the jury and for rendering a judgment in the case based on jury input;
wherein the jury observes the objects and object functionalities through demonstration of the objects in the virtual arena and supplies a verdict relative to the likeness of the objects to one another according to instruction given by the judge and wherein the judge renders a verdict based on statistical analysis of the opinions collected from the jury.

15. The virtual world of claim 14 wherein the number of actual jurors is larger than the representative avatars such that a single avatar represents multiple jurors having a same opinion.

16. The virtual world of claim 15 wherein when statistical analysis of actual jurors determines a number of same verdicts equal to the number of jurors represented by a single avatar, that avatar is assigned an opinion to render.

17. The virtual world of claim 14 wherein the opinions reached by actual jurors are transparent to the accuser and the accused.

18. The virtual world of claim 14 further including an avatar representing an enforcer for removing and or destroying a three-dimensional object deemed an infringing object by the assembled avatar jury.

19. The virtual world of claim 14 further including an avatar representing a court recorder for recording the case proceedings held within the virtual world.

20. The virtual world of claim 14 further including an avatar representing a prosecuting attorney for the accuser and an avatar representing a defending attorney for the accused.
